(19) United States
(12) Patent Application Publication
(10) Pub. No.: US 2014/0052787 A1
(43) Pub. Date: Feb. 20, 2014

(54) METHOD FOR OVERLAYING TIMELINES FOR EVENT-BASED SOCIAL NETWORKING

(71) Applicant: MySeat.com Media Inc., Point Claire (CA)

(72) Inventors: Normand PIGEON, Cookshire-Eaton (CA); Che HODGINS, Verdun (CA)

(73) Assignee: MySeat.com Media Inc., Point Claire (CA)

(21) Appl. No.: 13/969,678

(22) Filed: Aug. 19, 2013

Related U.S. Application Data
(60) Provisional application No. 61/684,240, filed on Aug. 17, 2012.

(51) Int. Cl. H04L 29/08

(52) U.S. Cl. CPC H04L 67/22
USPC 709/204

(57) ABSTRACT

A first timeline of sequenced experiences and a second timeline of sequenced experiences are provided. The first timeline includes first sequenced experience data associated with first time data. The second timeline includes second sequenced experience data associated with second time data. The first sequenced experience data and first time data and the second sequenced experience data and second time data are stored separately within a memory store. A portion of the second timeline is overlaid onto the first timeline, the overlaid portion comprising more than one sequenced experience separated by at least an experience within the first timeline to provide a display timeline, the display timeline for being displayed and including experiences from the first timeline and from the second timeline. Then, the display timeline is displayed on a display in sequence with the sequenced experiences of the first timeline and the sequenced experiences of the second timeline.

### FIELD OF THE INVENTION

The invention is related to the field of social networking and more particularly to the field of event based social networking.

### BACKGROUND

Social networking is a term that is applied to World Wide Web sites that incorporate a social aspect into their services. At first, social networking sites allowed for storage and retrieval of personal data beyond merely directory data.

One of the first popular social networking sites was MySpace®. MySpace® allowed users to define a space within their site that was personal to the user and reflected user taste, data, and connections. More recently Facebook® has become one of the largest social networking sites in the world. One advantage that Facebook® presented early on was the ability to use the social networking site to arrange social activities. One could post on their wall that they were going to a certain club and their friends would be able to comment—indicate that they were going. It was like telling your friends what you were doing and hearing their replies, but over the Internet instead of in person. Also, it allowed your friends to see each other's replies as if you had invited them all at the end of a class.

Unfortunately, with its wider dissemination, Facebook® has become less a tool for actual interaction and more a tool for virtual interaction. This is not a criticism as much can be accomplished through virtual interaction—photo sharing, messaging, email, status updates, and sharing of personal information, for example. That said, we are social beings and human interaction on a physical and local scale remain desirable.

The term “social networking” is also applied to tools that allow for social communication, such as Twitter® and to other sites/tools that enhance a user's social experience within the World Wide Web. These services maintain a list of social connections and are therefore considered social.

It would, however, be highly beneficial to apply social networking to physical networking and to physical events—events where those socializing are actually present at the event. Unfortunately, none of the existing tools supports a richly featured interactive networking solution.

### SUMMARY OF THE INVENTION

In accordance with an aspect of the invention there is provided a method comprising providing a first timeline of sequenced experiences, the first timeline comprising first sequenced experience data associated with first time data; providing a second timeline of sequenced experiences, the second timeline comprising second sequenced experience data associated with second time data; storing the first sequenced experience data and first time data and storing separately the second sequenced experience data and second time data in at least a memory store; overlaying at least a portion of the second timeline onto the first timeline, the overlaid portion comprising more than one sequenced experience separated by at least an experience within the first timeline to provide a display timeline, the display timeline for being displayed and including experiences from the first timeline and from the second timeline; and displaying the display timeline on a display in sequence with the sequenced experiences of the first timeline based on the first time data and the sequenced experiences of the second timeline based on the second time data, the first time data and the second time data providing time data relative between the first and second timeline.

In accordance with an aspect of the invention there is provided a method comprising providing a plurality of timelines each relating to one of a plurality of individuals and an event of a plurality of events; and selectively adding from the plurality of timelines timeline data to overlay with a timeline of an individual, the data relating to a same event as the timeline of the individual.

In accordance with an aspect of the invention there is provided a method comprising providing a plurality of timelines each relating to one of a plurality of individuals and a same event; and overlaying all of the timelines relating to the same event that are public, one on another to result in an omni-event timeline for the event.

In accordance with an aspect of the invention there is provided a method comprising providing a plurality of timelines each relating to one of a plurality of individuals and a same event; and overlaying all of the timelines relating to all events that are public, one on another to result in an all-event timeline.

In accordance with an aspect of the invention there is provided a method comprising providing an event timeline relating to an event having an event venue; joining the event by an individual and in response thereto forming an event timeline of the individual relating to the event; attending the event at a venue other than the event venue by the individual; and overlaying the event timeline of the individual over an event timeline of another individual, the event timeline of the individual comprising a plurality of sequenced experiences.

In accordance with an aspect of the invention there is provided a method comprising providing a plurality of timelines associated with an event; associating search data with each of the plurality of timelines, the search data stored in a data store in communication with a communication network; associating a first individual with the event, the first individual having an electronic communication device in communication with the communication network; searching by the first individual within in the data store for search data related to the event via the electronic communication device; and retrieving search data and providing at least of one of the plurality of timelines associated with the search data retrieved.

In accordance with an aspect of the invention there is provided a method comprising providing a plurality of timelines associated with an event; associating search data with each of the plurality of timelines, the search data stored in a data store in communication with a communication network; searching by a first individual within in the data store and relating to the event for search data via the electronic communication device; and providing an indication of an individual to whom the at least one of the plurality of timelines is associated.

### BRIEF DESCRIPTION OF THE FIGURES

FIG. 1 is a simplified diagram of a social network according to the prior art.

FIG. 2 is a simplified diagram of a social network according to an embodiment of the invention.

FIG. 3 is a simplified diagram of a social network wherein events are joined by individuals.

FIG. 4 is another simplified diagram of a social network wherein events are joined by individuals.

FIG. 5 is a simplified diagram of a timeline according to an embodiment of the invention.

FIG. 6 is another simplified diagram of a timeline according to an embodiment of the invention.

FIG. 7 is another simplified diagram of a timeline according to an embodiment of the invention.

FIG. 8 is a simplified diagram of a portion of a first timeline merged with a second timeline.

FIG. 9 is a simplified diagram of a timeline merged with the entirety of a second timeline.

FIG. 10 is a simplified diagram of a super timeline according to an embodiment of the invention.

FIG. 11 a simplified diagram of a traceable timeline according to an embodiment of the invention.

FIG. 12 shows a simplified block diagram of timeline experiences shared with third party social media networks.

FIG. 13 shows a simplified diagram of a timeline according to an embodiment of the invention.

FIG. 14 is a simplified diagram of an individual checked into an event via a virtual seat.

FIG. 15 is a simplified diagram of an event according to an embodiment of the invention.

FIG. 16 is a simplified diagram of an all-events timeline according to an embodiment of the invention.

FIG. 17 a is simplified diagram of the intersection of two timelines according to an embodiment of the invention.

FIG. 18 is a simplified diagram of two timelines searchable via timeline searchable data.

### DETAILED DESCRIPTION OF EMBODIMENTS OF THE INVENTION

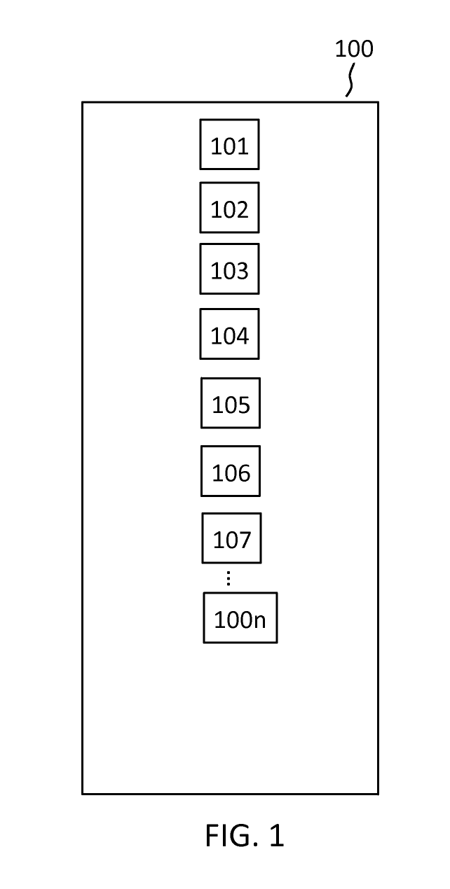

Referring to FIG. 1, shown is a simplified diagram of a social network according to the prior art. A user has provided their personal information including preferences, likes and dislikes. They have also linked up with a number of friends and have a “wall” on which friends post notes and messages. A news feed tells the individual what has been placed on peoples walls, what statuses people have provided, and highlights other noteworthy events that users linked to the individual have entered into their “page.” For example, the user's Facebook® page 100 shows the following posts: Gordon (the user) joins Facebook® (101); Gordon friended Sue (102); Gordon is married to Rashell (103); Gordon likes Ashley's cupcakes (104); Gordon is going to the hockey game (105); Gordon likes summer (106); Gordon is feeling tired all day (107); Gordon friended John (108) . . . Ashley's Cupcakes has a special today (100n).

Unfortunately, the social network of FIG. 1 relates to data entry of individuals and fails to adequately provide real life social experiences involving two or more people sharing an event together.

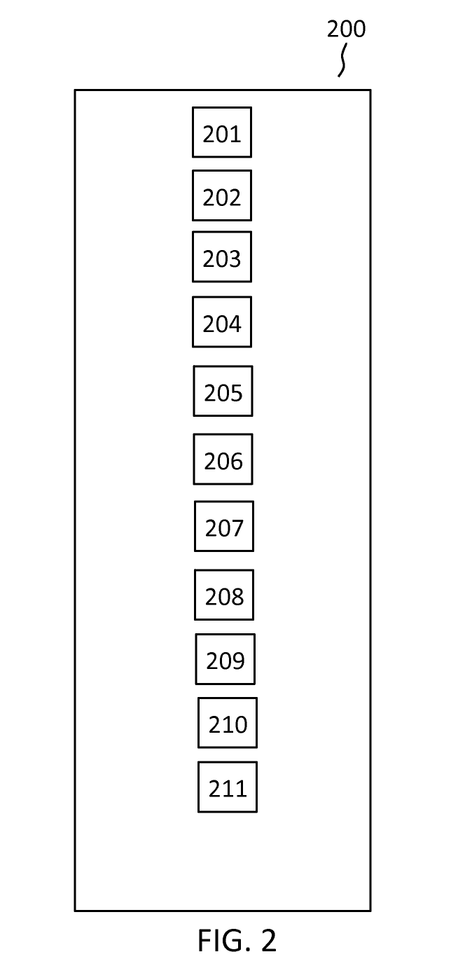

Referring now to FIG. 2, shown is a simplified diagram of a social network according to an embodiment of the invention. Here, an individual is linked to a number of “friends.” This, for example, is accomplished via the social network of FIG. 1, an existing third party social network, or a social network specific for the present purpose. When the individual attends an event, for example a sporting event, the individual is notified of linked individuals who are also present at the sporting event. In this way, the individuals share the event and can socialize with each other during the event. For example, the individual's Facebook® page 100 shows the following posts: Gordon joins Facebook® (201); Gordon friended Sue (202); Gordon is married to Rashell (203); Gordon likes Ashley's cupcakes (204); Gordon is going to the hockey game on November 15th (205); Gordon likes summer (206); Gordon is feeling tired all day (207); Gordon friended John (208). The next item posted on Gordon's Facebook® page, Gordon arrived at the hockey game (209), is automatically generated when Gordon's ticket is scanned upon entry at the hockey game. Furthermore when Gordon's friends arrive at the hockey game, and their tickets are scanned, the posts, Rashell arrived at the hockey game (210); and John arrived at the hockey game (211) are automatically generated and posted on Gordon's Facebook® wall. Gordon now knows that his friends Rashell and John are attending the same game as him and Gordon can contact them to meet up for after game drinks.

Alternatively, the post, Gordon has arrived at the hockey game (209), is automatically posted when the GPS in Gordon's smartphone detects that he has entered the hockey area. Further alternatively, the post, Gordon has arrived at the hockey game (209), is automatically posted when Gordon enters data into a software program indicating his arrival at the hockey area.

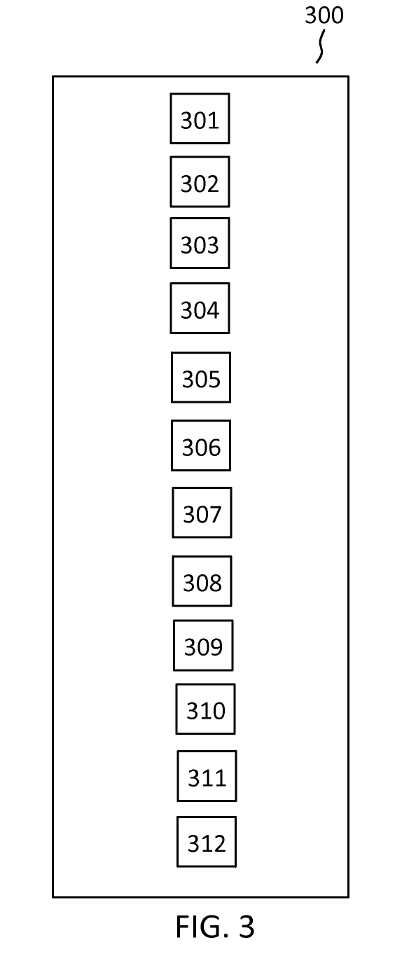

Referring to FIG. 3, shown is a simplified diagram of a social network according to another embodiment wherein timelines are created and events are joined by individuals. A timeline is created and an event is joined when an individual arrives at a venue related to the event. For example, when the individual arrives at a hockey arena to watch a hockey game. The individual's Facebook page shows the following posts: Gordon joins Facebook® (301); Gordon friended Sue (302); Gordon is married to Rashell (303); Gordon likes Ashley's cupcakes (304); Gordon is going to the hockey game on November 15th (305); Gordon likes summer (306); Rashell is going to the hockey game (307); Gordon is feeling tired all day (308); and Gordon friended John (309). The next item posted on Gordon's Facebook® page, Gordon arrived at the hockey game (310), is automatically generated when Gordon's ticket is scanned upon entry at the hockey game. Furthermore, an event timeline, in this example the hockey game timeline, is created and Gordon joins the hockey game event. When Gordon's friends arrive at the hockey game and their tickets are scanned, the posts, Rashell arrived at the hockey game (311); and John arrived at the hockey game (312), are automatically generated and posted on Gordon's Facebook® wall. A separate event timeline for both Rashell and John is created and Rashell and John each join their own hockey game event.

Alternatively, timelines are generated and events are joined when the GPS in an individual's smartphone detects that the individual has arrived at the event venue. Further alternatively, timelines are generated and events are joined when the individual enters data into a software program indicating his arrival at the event venue.

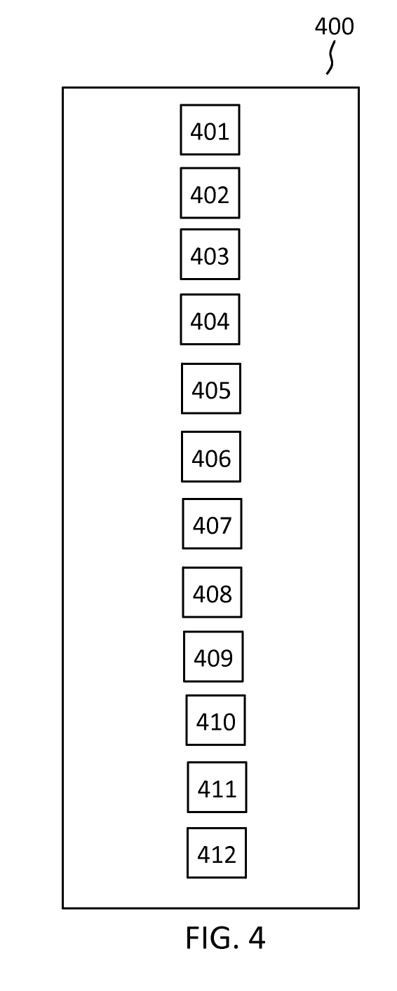

Referring to FIG. 4, shown is a simplified diagram of a social network according to another embodiment of the invention wherein events are joined by individuals. An event is joined when an individual decides to attend. The individual is then notified of linked individuals that are also planning to attend the event. For example, when an individual buys their tickets for a sporting event, the event is joined by that individual. Now the individual can see who amongst their linked “friends” is planning on attending the event and can arrange with them to socialize during the event, before the event, or after the event. Further, the individuals can plan follow up get-togethers—for example meet up to talk about the event when we get back if the sporting event is somewhere else. The individual's Facebook page shows the following posts: Gordon, joins Facebook® (401); Gordon friended Sue (402); Gordon is married to Rashell (403); and Gordon likes Ashley's cupcakes (404). The next item posted on Gordon's Facebook® page, Gordon is going to the hockey game on November 15th (405) is automatically generated when Gordon's ticket is scanned or photographed, for example, by his smartphone. Furthermore, an event timeline, in this example a hockey game timeline, is created and Gordon joins the hockey game event. The following post, Rashell is going to the same hockey game (406) is automatically generated when Rashell's ticket is scanned or photographed, for example, by her smartphone. Furthermore, an event timeline, in this example the hockey game timeline, is created and Rashell joins the hockey game event. Other posts include Gordon likes summer (407); Gordon is feeling tired all day (408); Gordon friended John (409) and Gordon arrived at the hockey game (410); When Gordon arrives at the hockey game his ticket is scanned and he “checks into” the hockey game event. Checking into the event occurs when the individual arrives at the event venue. The next post, Rashell arrived at the hockey game (411); indicates that she has also “checked into” the hockey game event. The next post John arrived at the hockey game (412), is automatically generated when John's ticket is scanned upon entry at the hockey game. Furthermore, an event timeline, in this example the hockey game timeline, is created, and John joins and “checks into” the hockey game event.

Alternatively, timelines are generated and events are joined when the GPS in an individual's smartphone detects that the individual has arrived at the event venue. Further alternatively, timelines are generated and events are joined when the individual enters data into a software program indicating his arrival at the event venue.

Alternatively, an individual checks into an event when the individual enters data into a software program to indicate that the individual has arrived at the event venue.

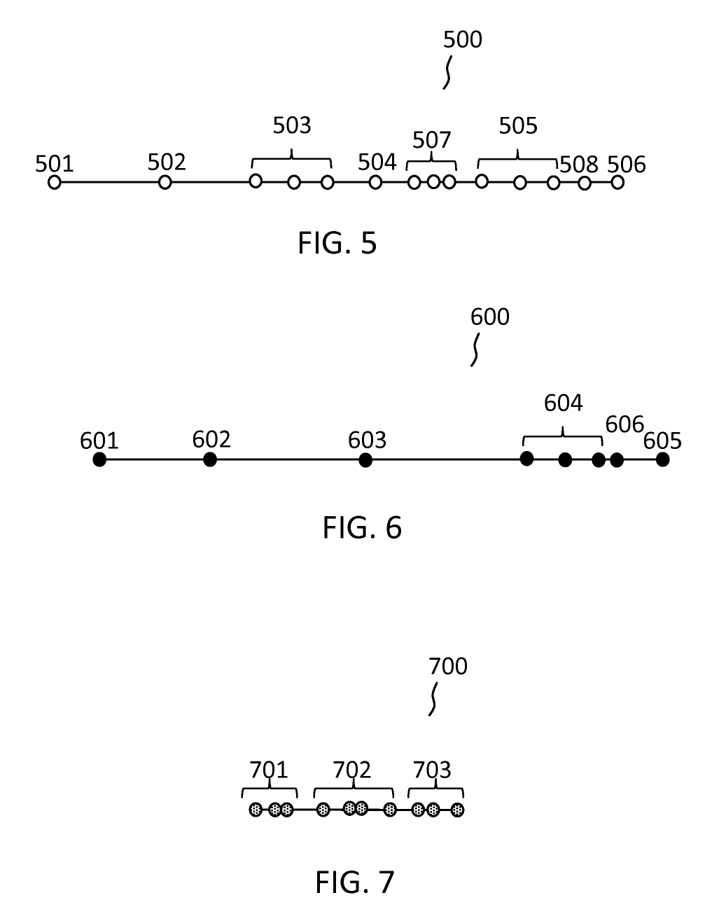

Shown in FIG. 5 is a simplified diagram of a timeline according to an embodiment of the invention. Timeline 500 relates to a single event, for example a sporting event. Timeline 500 is made up of experiences sequential in time relating to an individual.

For example, on November 1st, the individual bought a ticket to a November 15th hockey game. The individual scans the ticket's bar code and joins the event, timeline 500 for the hockey game is created and a first experience (501) is entered into timeline 500. Though created on November 1st, timeline 500 relates to an event on November 15th—the hockey game. The individual on November 6th enters into the timeline the fact that he will celebrate or mourn the game's outcome at a sport bar near the rink after the game (502). This entry is posted on the individual's third party social networking website and friends linked to this individual, via the third party social networking website, see that he is attending. Three of his friends who are also going to the game make contact with him. Alternatively, when his friends scan their tickets and join the event the individual sees that his friends have arrived at the event venue and the individual contacts his friends instead. For the next 5 days (503) several communications regarding making plans for the game are shared between the four friends and each communication is entered into timeline 500. The table at the sports bar is reserved on November 10th (504) and the arrangements are made. Entries on the day of the game relating to preparing for the game, car-pooling to the game and arriving at the game are added to timeline 500 (507).

Each experience is logged in the individual's timeline 500 according to the time and date that the experience occurred. On November 15th, during the event, game related experiences (505) are entered into timeline 500. Finally, once the game is done, the timeline transitions to the post game events at the sport bar (508) and concludes with the individual arriving home (506). Upon reviewing the timeline, it captures the user's experiences of a single sporting event. The individual views his event timeline 500 on a smartphone, tablet or computer screen. The experiences are presented in a sequential fashion such that they are organized according to the day and time they were entered into timeline 500.

Alternatively, the timeline is created when the individual joins the event via a software program.

Now referring to FIG. 6, shown is another event timeline 600 relating to the same hockey game of November 15th, but for another member of the group of four individuals that car-pooled together. Timeline 600 is very similar to timeline 500, but the actual entries differ. For example, the ticket was purchased on June 5th (601) as opposed to November 1st. Other experiences in timeline 600 include pictures of the friend wearing the home team's jersey on November 7th (602), commentary he made predicting the outcome of the game on November 11th (603), and pictures he took during the game (604). Finally, once the game is done, the timeline transitions to the post game events at the sport bar (606) and concludes with the friend arriving home (605). Optionally, the experiences that he shared with the individual are also included in timeline 600, for example the correspondence between the four friends at 503 in FIG. 5 (not shown for clarity).

Now referring to FIG. 7, shown is a simplified diagram of another event timeline 700, but this time referring to the actual sporting event. Here, sporting event entries are seen as they have been entered, for example by a newsman working the event. For example, 30 minutes before the game the newsman gives a commentary (701) of the line-up for the game, injured players, and a recap of the last game the playing teams played. During the game (702), the newsman comments on goals, team performance, plays and provides related video. After the game (703), the newsman provides a commentary on the score of the game, most valuable player and other highlights of the game. Though these experiences are not all shown in the timelines of FIGS. 5 and 6, the individuals at the game were privy to most if not all of the same happenings within the game.

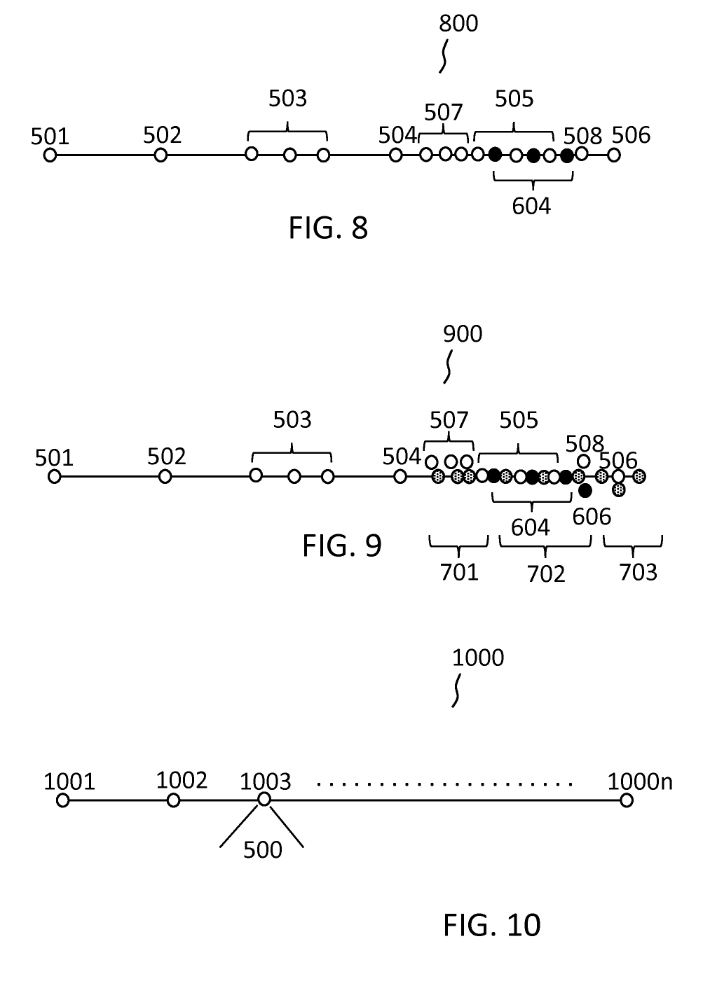

Now referring to FIG. 8, shown is a simplified diagram of a portion of timeline 600 merged with timeline 500. For example, the individual would like to include the pictures that his friend took at the game that are entered into timeline 600. However, he does not wish to include his friend's entire timeline. Once the individual's friend shares his timeline with the individual, the individual selects a portion of the timeline 600 to overlay on top of timeline 500. The portion he selects is at 604 of timeline 600, which contains pictures of the game. The individual views timeline 800 on a smartphone, tablet or computer screen. The timeline 500 and timeline 600 remain separately stored allowing for viewing of each separately or combined. The experiences are presented in a sequential fashion such that they are organized according to the day and time they were entered into their original timelines.

Alternatively, the first individual selects only the pictures (experiences) that he likes the best and merges those with timeline 500. Further alternatively, the first individual merges the entire timeline 600 with timeline 500.

Referring to FIG. 9, shown is a simplified diagram of timeline 700 merged with the entire timeline 800. The newsman's timeline is publicly available and can be merged with anyone's timeline. Now the news of the game is inserted within the timeline of the first individual, and a portion of the second individual, showing their experiences and the game happenings in a single combined timeline. Of course, the three timelines remain separately stored allowing for viewing of each separately or combined. Since both the individuals shared the game experience, they share a commonality of timelines but each timeline is different. For example, if the second individual caught a puck they would add an experience in to their timeline. That clearly did not happen in the general news or to the first individual.

Once the event is over and timeline 900 has ended, the individual has the ability to view timeline 900 at any time in the future. Optionally, the individual adds experiences to his timeline line after the timeline is completed. For example, he adds to timeline 500 a picture of the player that scores a goal, at the time the goal is scored. Furthermore, after the event is closed, the first individual merges a second friend's timeline with timeline 900 and he views the four timelines merged together. Alternatively, the first individual other than merges the second friend's timeline with timeline 900 and views the second friend's timeline separately. Further alternatively, the individual removes the portion of timeline 600 from the timeline 900 and views timeline 500 merged with timeline 700.

Shown in FIG. 10 is a simplified diagram of a super timeline according to an embodiment of the invention. A super timeline is associated with an event that comprises multiple sub-events. Each sub-event is associated with its own timeline. A specific and non-limiting example is a hockey season event associated with super timeline 1000. The hockey season event comprises sub-events such as hockey games 1001, 1002, 1003, . . . 1000n and each hockey game has its own timeline. For example, sub-event 1003 is the hockey game that the individual attended on November 15th and is associated with timeline 500. He also attended hockey games 1001, 1002, . . . 1000n and each sub-event has corresponding timelines. The individual views timeline 1000 on a smartphone, tablet or computer screen. He can also view each sub-event timeline. The sub-events and experiences are presented in a sequential fashion such that they are organized according to the day and time they were entered into timeline 1000.

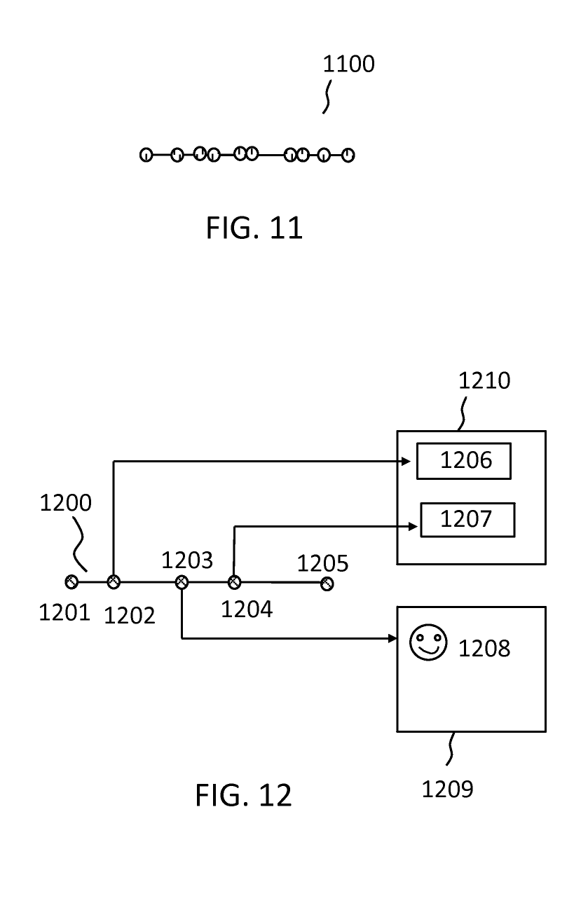

Referring to FIG. 11, shown is a simplified diagram of a traceable timeline according to an embodiment of the invention. A traceable timeline is a timeline that is automatically generated based on activity of the user, yet not entered into the timeline by the user. A specific and non-limiting example is credit card timeline 1100. During the hockey event on November 15th the first individual made several purchases with his credit card, such as his ticket, beer before the game, popcorn during the first intermission, a home team jersey during the second intermission, beer at the sports bar, etc. When the first individual receives his credit card bill he does not recall all of the purchases indicated on the bill during the hockey game event and wonders if some of the purchases are invalid. To jog his memory he overlays the credit card timeline 1100 onto timeline 900 and reviews the merged timelines on either a smart phone, tablet or personal computer screen. As the purchases are now visible and in sequence with the experiences of timeline 900, viewing the merged timelines aids him in recalling the purchases on his bill.

According to an embodiment of the invention timelines are instantaneously merged. For example, instead of the individual merging the newsman's timeline 700 with timeline 800 after the event is over he selects the newsman's timeline for real time merging with his own timeline 500. Doing so allows the individual visibility of the newsman's experiences as soon as they are entered into timeline 700.

Now referring to FIG. 12, shown is a simplified block diagram of timeline experiences shared with third party social media networks. Timeline 1200 is associated with an event, a specific and non-limiting example is a music concert. An individual has accounts with third party social media networks, for example Twitter® 1210 and Facebook® 1209. The event timeline begins at 1201 when she purchases her ticket and joins the event. Her ticket is scanned at the entrance and she is checked into the concert at 1202. Alternatively, she checks into the concert by entering data into a software program. Further alternatively, she is checked into the event when she arrives at the event venue. The experience of arriving at the concert is not only entered into timeline 1200 but also posted as a tweet 1206 on her Twitter® account 1210. The next experience entered into her timeline is a picture she takes of her friends (1203) which is then automatically posted on her Facebook® page 1208. At 1204 she enters an experience about the band into timeline 1200 which is posted as a tweet 1207 on her Twitter® account 1210. Not all of her experiences are shared with the third party social media networks, for example, purchasing her ticket at 1201 and the end of the concert at 1205 are entered as experiences in timeline 1200 but not posted on Twitter® or Facebook®. Alternatively, entries by the individual into third party social media sites are incorporated into timeline 1200. For example, tweets that the individual sends out during the event are entered into timeline 1200 as sequenced experiences. Further alternatively, any new entries into her Facebook® timeline that occur during the event are also entered into timeline 1200 as sequenced events.

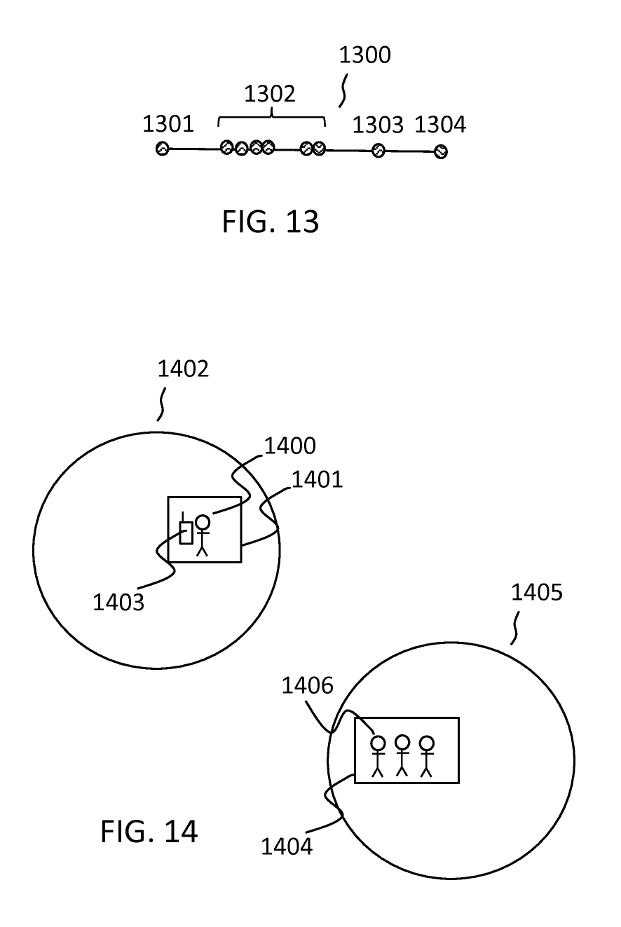

Shown in FIG. 13 is another simplified diagram of a timeline according to an embodiment of the invention. A friend of the individual described in the example of FIG. 12 is unable to attend the concert, however she plans to watch the live concert on TV. Timeline 1300 is created when the friend joins the concert (1301) by entering data into a software program. The friend sees that the individual has joined the event, and during the concert exchanges text messages with her (1302) and they decide to share their timelines with each other (1303). Finally, the concert ends (1304) as does timeline 1300.

According to an embodiment of the invention an individual optionally joins and checks into an event in the following ways: an event ticket is scanned using an electronic device and ticket information is provided to the individual's timeline, a individual enters data via a media interface into a software program or a individual is presented with a map on his mobile device showing the locations of various events that are ongoing nearby and selects the event he wishes to join/check into. Alternatively, a individual checks into an event when he is detected at the event venue via the GPS in the individual's mobile device.

According to an embodiment of the invention an individual has a virtual seat to an event wherein he joins and checks into an event without physically attending the event venue. For example, in FIG. 14 shown is an individual 1400 at a sports bar 1401 in Montreal 1402. He joins and checks into an event, for example a hockey game, by entering data into an event software program via an electronic device, for example his smartphone 1403. The hockey game is taking place in hockey arena 1404 located in New Jersey 1405. The individual 1400 is a fan of the Montreal Canadiens® who are playing against the New Jersey Devils® in New Jersey that evening. Several of the individual's friends 1406 are attending the game in New Jersey 1405 in support of their home team, the Canadiens®, while he is watching the game from the sports bar 1401 in Montreal 1402. His friends 1406 check into the game by scanning their tickets. One friend shares his timeline with the individual and the individual overlaps his friend's timeline with his own. Now the individual can share in his friend's experiences although he is located at the sports bar 1401 and not the arena 1404. The individual takes a picture of himself 1400 wearing the team's jersey and enters it into his timeline. In response his friend takes a picture of all of the friends wearing their jersey's at the arena 1404. Throughout the game the individual and friend exchange texts commenting on plays and goals and the texts appear in both the individual's and friend's timelines. Furthermore, the friend takes pictures of the game and enters them into his timeline to share with the individual. A virtual seat provides the same timeline functionality as a physical seat at the event venue.

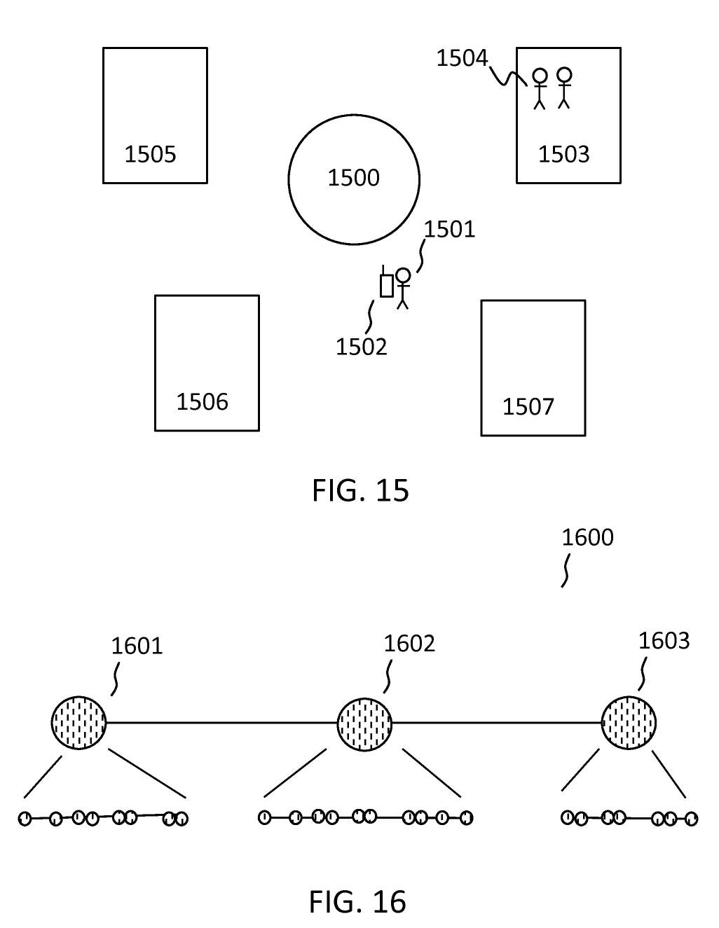

According to another embodiment of the invention venues located close to an event venue have venue timelines. Shown in FIG. 15, for example, an event in the form of a rock concert at arena 1500, is starting at 9:30 pm in the evening. An individual 1501 has tickets to the concert and plans on arriving at 9 pm. However, he is interested to know what is happening at other venues near the rock concert. He is provided a map on his mobile device 1502 of the local area and locations of venue that have timelines. For example, venue timelines are public to those who have joined an event. Alternatively, venue timelines are public. The individual selects a venue, for example a pub 1503, and reviews the pub's timeline looking for information as to what is happening there. There are entries of patrons competing in a karaoke contest. Also visible to the individual are the names of others who have joined the venue timeline. He notices that some of his friends 1504 have joined the venue timeline and he decides to visit them at the pub 1503 prior to attending the concert. Alternatively, the individual selects one of the other nearby venues such as restaurant 1505, sports bar 1506, or coffee shop 1507.

According to an embodiment of the invention an omni-event timeline includes experiences from every individual that has joined a particular event. For example, 80,000 people attend a soccer game while another 200,000 are watching the game on TV. Of the 280,000 fans, 160,000 have joined the soccer game event. 120,000 of the joined members have made their timelines public, meaning that the timelines can be shared with anyone who wishes to see them. A omni-event timeline includes all the experiences that have been publicly shared by joined members. When a member views this omni-event timeline he has access to thousands experiences of thousands of individuals including pictures, audio and video files, and messages between fans. This provides a unique experience for the members as they can share this same event experience with people from around the world.

According to another embodiment of the invention an all events timeline includes omni-event timelines for all events. Shown in FIG. 16, is an all-events timeline 1600 comprising three omni-event timelines. For example, on a given weekend there are 3 events happening: the soccer game 1601 mentioned immediately above, a rock concert 1602, and a festival 1603. Each event has joined members that share their timelines with the public. An all event timeline includes the omni-event timelines of the soccer game, rock concert and the festival. Members of each event have visibility of the experiences added to the all-event timeline that is contributed to by each member that publicly shares their experiences. Optionally any future events will be added to the all event timeline, creating a living timeline.

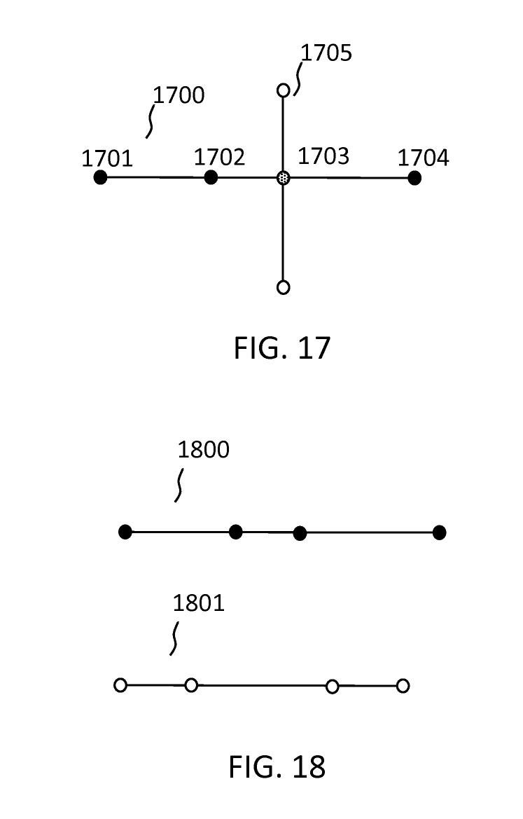

According to an embodiment of the invention an experience is shared amongst multiple timelines. For example, in FIG. 17, shown is a holiday weekend timeline 1700 of an individual. He enters experiences into this timeline for example plans for dinner with his extended family 1701, cooking, preparation 1702 and finally eating dinner 1704. During the holiday weekend he also attends his son's little league baseball game. The little league experience 1703 is not only entered into his holiday weekend timeline 1700 but also his little league season timeline 1705. This is accomplished by one of the following: storing a single experience entry and providing a link to the experience entry to each of multiple timelines; storing multiple experiences entries one within each of the plurality of timelines and storing one experiences entry within one of the plurality of timelines and a storing a link thereto of other(s) of the plurality of timelines.

According to an embodiment of the invention timelines and/or individuals are searchable via data associated with the timelines that is stored in the event data store. For example, shown in FIG. 18 are timelines 1800 and 1801. Timeline 1800 comprises audio announcements of an event in the form of a hockey game by an English commentator, whereas timeline 1801 comprises audio announcements of the same hockey game by a French commentator. Both timelines 1800 and 1801 are stored into the event data store in real time and have been tagged with identifiers, for example metadata, for searching purposes. An individual joins the hockey game event and, using a software interface of an electronic device, searches for the French commentator timeline to overlay onto the individual's timeline. The individual enters search terms such as hockey, French, sports broadcaster etc. into a search window of the software program and the French commentator's timeline is found. The individual is given a choice via the software interface to overlay the French commentator's timeline's onto his own timeline, which he chooses to do. Alternatively, the individual searches for the English commentator's timeline to overlay onto his own timeline. Further alternatively, the first individual searches for another individual based on an event within the other individual's timeline. For example, the first individual answers the question, “who had the most beer at last night's game?”

As used herein the term he is representative of an individual and is to be seen as including individuals of all sexes.

Numerous other embodiments may be envisaged without departing from the scope of the invention.

What is claimed is:

1. A method comprising:
providing an event timeline relating to an event having an event venue;
joining the event by an individual and in response thereto forming an event timeline of the individual relating to the event;
attending the event at a venue other than the event venue by the individual; and
entering event related timeline data relating to the event at the venue other than the event venue.

2. A method according to claim 1 comprising:
overlaying the event timeline of the individual over an event timeline of another individual, the event timeline of the individual comprising a plurality of sequenced experiences represented by the event related timeline data.

3. A method according to claim 2 comprising:
entering event related timeline data relating to the event and the another individual.

4. A method according to claim 3 wherein the another individual attends the event at the event venue.

5. A method according to claim 3 wherein the another individual attends the event at the venue other than the event venue.

6. A method according to claim 3 wherein the another individual attends the event at another venue other than the event venue.

7. A method according to claim 3 comprising:
establishing a real-time communication path between the individual and the another individual in response to both attending the event.

8. A method according to claim 7 wherein the real-time communication path is established during the event.

9. A method according to claim 1 comprising:
providing exclusive event attendee options to the individual once they attend the event at a venue other than the event venue.

10. A method according to claim 9 wherein the exclusive event attendee options comprise event exclusive offers.

11. A method according to claim 1 comprising:
displaying a map of an area about an event to the another individual; and
selecting by the another individual one of a venue proximate the event and a venue of the event to attend.

12. A method according to claim 11 wherein displaying comprises displaying a location of friends of the individual.

13. A method according to claim 11 wherein displaying comprises displaying data relating to each of a plurality of events within a same geographic area.

14. A method according to claim 1 comprising:
displaying a map of an area about an event; and
selecting by the individual a venue proximate the event venue wherein the venue timeline is available to the public.

15. A method according to claim 14 comprising:
overlaying the venue timeline on the event timeline of the individual.

16. A method comprising:
providing an event having a known event venue;
joining the event by an individual;
attending the event at a venue other than the event venue by the individual; and
automatically providing to the individual via a personal communication device information relating to the one of the event and other individuals who joined the event.

17. A method according to claim 16 wherein the information comprises shared communications via a communication channel created automatically between the individual and another individual.

18. A method according to claim 16 wherein the information comprises event information relating generically to the event and shared via a communication channel created automatically between the individual and an event communication server.

19. A method comprising:
providing an event timeline relating to an event having an event venue;
joining the event by an individual;
attending the event at a venue other than the event venue by the individual; and
providing to an event organizer, event data relating to the individual other than data relating to ticket payments by the individual.

20. A method according to claim 19 comprising:
providing to an event organizer, event data relating to a plurality of individuals who have each joined the event and attended the event at a venue other than the event venue, the event data other than data relating to ticket payments by the plurality of individuals.
